(19) United States
(12) Patent Application Publication
(10) Pub. No.: US 2024/0351284 A1
(43) Pub. Date: Oct. 24, 2024

(54) A Method And Apparatus For Making Core For Composite Objects

(71) Applicant: Massivit 3D Printing Technologies Ltd., Lod (IL)

(72) Inventor: Shai Hirsch, Rehovot (IL)

(21) Appl. No.: 18/691,913

(22) PCT Filed: Jan. 26, 2022
(86) PCT No.: PCT/IL2022/050078

§ 371 Date: Mar. 14, 2024

(51) Int. Cl. B29C 64/30; B29C 70/78; B29K 33/00; B29K 105/08; B29K 277/00; B29K 305/00; B29K 309/08; B33Y 40/20

(52) U.S. Cl. CPC B29C 64/30; B29C 70/78; B33Y 40/20; B29K 2033/00; B29K 2105/08; B29K 2277/10; B29K 2305/00; B29K 2309/08; B29K 2995/0097

(57) ABSTRACT

The present document discloses an automated method and apparatus to manufacture almost any shape strength and stiffness enhancement structures from composite materials. The method supports the manufacture of strength and stiffness enhancement structures that follow the curved surfaces.

### TECHNOLOGY FIELD

The method and apparatus relate to the manufacture of core from composite materials for 3D objects.

### BACKGROUND

A composite material is a material that includes at least two individual components. Typically, the composite material consists of two skins and a fibrous reinforcement or core placed between the skins. Composite materials achieve beneficial properties from a strong bond between the skins and a solid and stiff core. The reinforcement is usually fibers (filaments) or reinforcements with different geometrical shapes, for example, honeycombs, triangles, ribs, and some particles. The fibers could be glass fiber, Kevlar, Carbon Fiber, or others. A resin, for example, epoxy, polyester resin, or vinyl ester, binds mechanically and chemically the geometrical shapes and/or fibers and the skins into a composite part.

The composite material is the primary manufacturing material (build material) of 3D objects, including large 3D objects. Composite materials are popular for several reasons; they are lightweight and have high mechanical strength. The reinforcement structures placed between two sheets or skins of composite material and laminated or glued to the skins make the mechanical strength of composite material similar to the strength of solid metal with the same dimensions.

The manufacture of the composite materials reinforcement structures s usually a process separate from the manufacture of the composite object. The structures are manufactured and shaped, and joined into parts meeting the desired size of the final composite object.

The skins and strength and stiffness structures forming a composite object are joined together under vacuum or pressure by resin or glue that bonds the layers. Once the resin has hardened, the two or more parts are pieced together to form a composite object.

The still labor-intensive assembly process where layers of laminates are layed-up one over the other, combined with one or more layers of reinforcement structures, complicates the composite object manufacture.

### Definitions

The term “strength and stiffness enhancement structures” means a layer of different geometric figures laminated or glued between one or more skins of a 3D object. The strength and stiffness structures could be selected to enhance the mechanical strength of a 3D object in one or more directions.

The term “b-stage resin” refers to an epoxy that has been cured for a short period and then cooled (quenched) to prevent complete polymerization of the resin system. At this point, it is a solid that has been partially cured (typically less than 10%) and is still available for bonding parts together.

The term “fiber tape” means a strip of resin-impregnated material.

The present disclosure uses the term “predetermined movement path or pattern”, meaning a combined liner and transversal movement pattern of the material dispensing head.

### SUMMARY

The present document discloses an automated method and apparatus to manufacture almost any shape strength and stiffness enhancement structures from composite materials. A composite material three-dimensional object could include curved and flat skins. A strength and stiffness enhancement structure located between the skins provides the strengths of the composite three-dimensional object. The present strength and stiffness enhancement structure follows the curvature of at least one of the curved skins. The strength and stiffness enhancement structure could be manufactured from the same composite material as the skins or different composite materials.

The strength and stiffness enhancement structure could be one of a group of structures, including a grid-like structure with identical pitch and arbitrary direction lines with variable pitch. The strength and stiffness enhancement structure is a structure of a series of ribs perpendicular to the curved skin on which they are located. The a series of ribs could have a variable pitch and thickness.

When the skins of the three-dimensional curved object are parallel flat planes or concentric curves, the ribs of the strength and stiffness enhancement structure are uniform. The ribs have the same height; when the skins of the three-dimensional curved object are not concentric or flat surfaces are not parallel between them. The ribs of the strength and stiffness enhancement structure are non-uniform and change their height following the gap between the skins.

The strength and stiffness enhancement structure could be placed between the skins to enhance the stress resistance of the three-dimensional curved object in a preset direction.

### LIST OF FIGURES AND THEIR BRIEF DESCRIPTION

To understand the apparatus and method and to see how could be carried out in practice, examples will now be described, by way of non-limiting example only, with reference to the accompanying drawings, in which identical referral numbers mean identical or similar parts:

FIG. 1 is a side view of an existing 3D object from a composite material, including the strength and stiffness enhancement structure;

FIG. 2A is a side view of an apparatus for placing a resin impregnated tape for a strength and stiffness enhancement structure;

FIG. 2B is a front view of an apparatus for placing a resin impregnated tape for a strength and stiffness enhancement structure;

FIG. 2C is an example of a single strip of resin-impregnated tape produced by apparatus for manufacturing a resin impregnated tape FIGS. 2A and 2B;

FIG. 2D illustrates another example of a resin-impregnated tape to be employed in forming a strength and stiffness enhancement structure

FIG. 3 is a view from arrow C direction and an example of different geometric shapes of the resin-impregnated tape produced by different movement patterns of the dispensing head and advance of the resin-impregnated tape;

FIG. 4 is a side view an example of a modified apparatus 200 adapted for the manufacture of a core for a composite material three-dimensional object;

FIG. 5 is a frontal view of the modified apparatus of FIG. 4;

FIG. 6 is an example where several resin-impregnated material tapes are placed and joined as a multi-layer laminate to enhance the strength of the support structure;

FIG. 7 is an example of a 3D object formed by not concentric curved surfaces and a corresponding strength and stiffness enhancement structure;

### DESCRIPTION

Despite the weight, environmental stability, and strength advantages of composite materials, the labor-intensive and time-consuming manufacturing methods impede the growth and use of the materials. The existing strength and stiffness enhancement structures manufactured predominantly as flat sheets and their processing into other shapes is problematic. Improper designed or oriented strength and stiffness enhancement structures do not increase the three-dimensional object strength. The dimensions and walls of the strength and stiffness structures do not support equal strength of the three-dimensional object in every direction. Delamination of skins and strength and stiffness enhancement structures occurs when the composite object is subject to bending forces. Additionally, the strength and stiffness enhancement structure becomes damaged and cracked, and the composite object loses its strength.

The availability of a low-cost and automated manufacturing process that would significantly reduce the labor-intensive operations and maintain the manufactured object quality would rapidly advance the industry.

The present document discloses an automated method and apparatus to manufacture almost any shape strength and stiffness enhancement structures from composite materials. The method supports the manufacture of strength and stiffness enhancement structures from the same or different material as the composite object, including complex-shaped three-dimensional objects from composite material.

The method simplifies the assembly of different shape skins and strength and stiffness enhancement structures into one 3D object.

The suggested method would reduce the manufacturing cost and provide a better degree of 3D object profile precision.

The document also discloses a multistrand filament with an acrylic matrix or another fast-curing material surrounding the multistrand core. A coating of the extruded multistrand core by the acrylic material supports almost instant hardening of the combined multistrand material and simplifies the curing process.

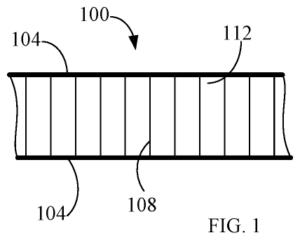

FIG. 1 is a side view of an existing 3D object from a composite material, including the strength and stiffness enhancement structure. Object 100 includes two skins or walls 104 and a strength and stiffness enhancement structure 108 laminated or glued between skins 104. Reference numeral 112 marks a layer of resin or glue that facilitates bonding the skins 104 and strength and stiffness enhancement structure 108. The desired strength of the manufactured three-dimensional object determines the density of the strength and stiffness enhancement structure pattern. The higher the strength and stiffness enhancement structure percentage, the stronger the manufactured composite object, although the strength and stiffness enhancement structure percentage over 50% does not add extra strength.

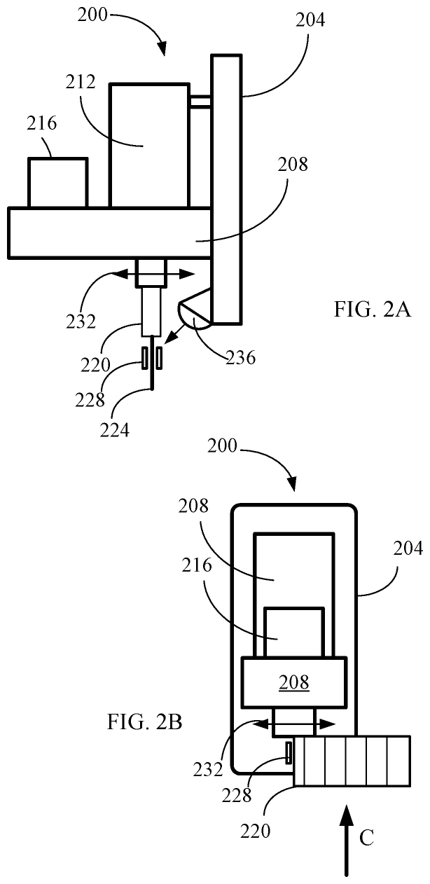

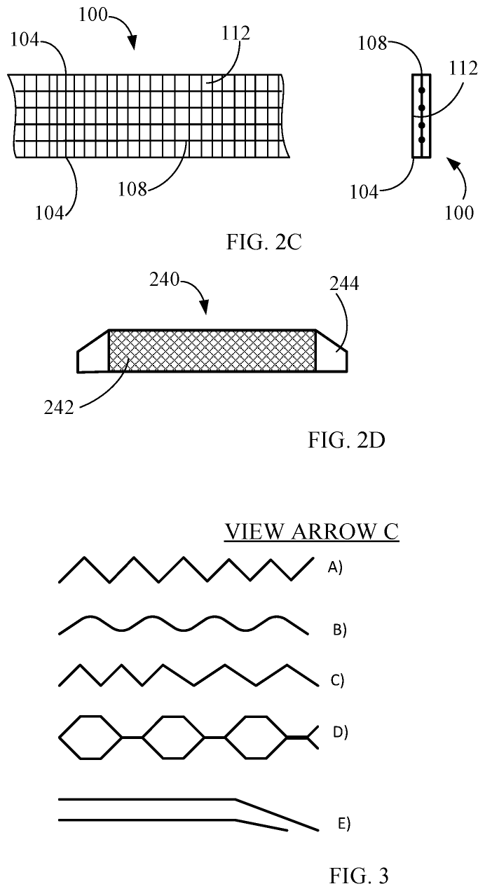

FIG. 2A is a side view of an apparatus for placing a resin impregnated tape for a strength and stiffness enhancement structure. The resin serves as a matrix for the resin-impregnated tape manufacture. Apparatus 200 includes a stand 204 that supports a resin supply vessel 212 and a magazine 216 of materials that increase the strength of a resin-impregnated tape. Resin impregnation device 208 mixes the resin with materials that increase the strength of a resin-impregnated tape and tape dispensing head 220 dispenses a resin-impregnated tape 224. In some examples, prepared ahead of time resin-impregnated tape could be used. The materials that increase the strength of the resin-impregnated tape 224 could be glass fibers, fabric, Kevlar™, and metal wire. The resin could be acrylic material or another fast-curing material. Alternatively, a tape with a matrix of thermoplastic material could be used. The tape could be heated and hardened by cooling for proper placement and attachment. As such, the resin-impregnated tape 224 or a tape with a matrix of thermoplastic material are composite material.

Apparatus 200 further includes a dispenser with a material dispensing head 220 that dispenses a resin-impregnated tape 224 and at least two (pair) rollers 228. A pair of rotating rollers 228 receives resin-impregnated tape 224. The rotation of rollers 228 advances resin impregnated tape 224 along a predetermined path direction. Dispensing head 220, as shown by arrow 232, is configured to follow a predetermined movement pattern during the resin-impregnated tape 224 dispensing. The predetermined path of dispensing head 220 could have variable amplitude and pitch. Apparatus 200 also includes a source 236 of resin-impregnated tape 224 curing radiation.

FIG. 2B is a front view of an apparatus for manufacturing a resin impregnated tape for a strength and stiffness enhancement structure. A single strip of resin-impregnated tape 224 could have a thickness of 0.1 mm to 3.0 mm (FIG. 2C). The length of resin-impregnated tape 224 practically is not limited. Upon extrusion, resin-impregnated tape 224 is cut to size. FIG. 2C illustrates an example of a resin-impregnated tape 220 to be employed in forming a strength and stiffness enhancement structure. The resin-impregnated tape 200 strength enhancement could be unidirectional, bi-directional, or multidirectional.

FIG. 2D illustrates another example of a resin-impregnated tape 240 to be employed in forming a strength and stiffness enhancement structure. The core 242 of resin-impregnated tape 240 where the edges 244 of resin-impregnated tape are tapered with balsa or some other formable material, for example, polyurethane foam.

FIG. 3 is a view from arrow C direction and an example of different geometric reinforcement shapes of the resin-impregnated tape 224 produced by simultaneous oscillations of the dispensing head 220 and advance of the resin-impregnated tape 224. The geometric reinforcement shapes of the resin-impregnated tape 224 could be of any arbitrary shapes, for example, honeycombs (FIG. 3D), triangles (FIG. 3A), waive (FIG. 3B), linear (FIG. 3E). The different geometric reinforcement shapes could have a fixed or variable pitch (FIG. 3C).

### Core Manufacture

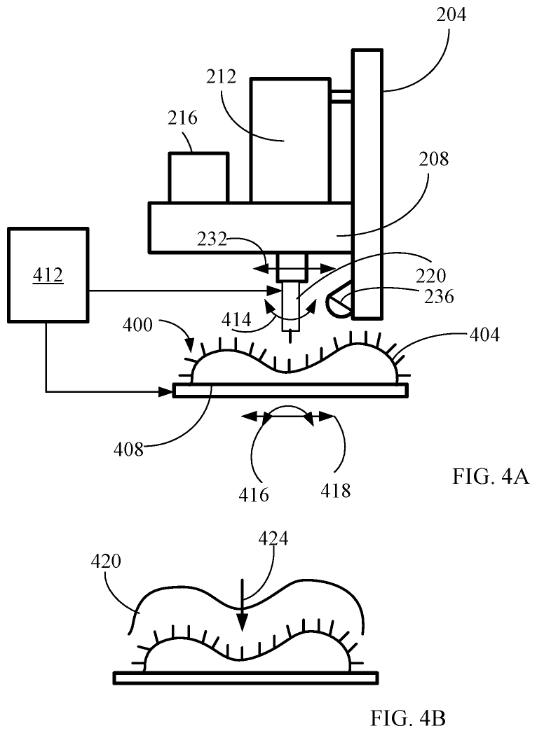

A modified apparatus 200 (FIG. 4) could be used to manufacture a core for a composite material three-dimensional object, including a curved 3D composite object. The manufacturing method includes providing or delivering a curved 3D composite object 400 with curved skins 404, the strength of which has to be enhanced. Curved 3D composite object 400 could be placed on a support surface 408.

A CAD system could provide the surface parameters. Alternatively, the surface parameters could be measured or scanned using a suitable scanner for scanning three-dimensions objects. Based on the surface parameters, operating material dispensing head 220 dispenses a preset length of resin-impregnated tape 224 and cuts the preset length of dispensed resin impregnated tape 224. The material dispensing head 220 moves along a predetermined path, and in the course of dispensing, the resin-impregnated tape the material dispensing head 220 oscillates. The predetermined path of material dispensing head 220 has variable amplitude and pitch. The predetermined path shape of material dispensing head 220 includes a group of sinusoidal, triangular, rectangular, and arbitrary shapes.

The material dispensing head 220 oscillation amplitude is up to 100.0 mm.

The predetermined path is also a path where the material dispensing head 220 deposites resin-impregnated tape to enhance the strength and stiffness of the curved surfaces of the curved 3D composite object 400. Material dispensing head 220 predetermined path mean periodic, repetitive, and free movements.

A computer 412 receives the 3D object parameters from a CAD system and synchronizes the movement of surface 408 with predetermined path of material dispensing head 220. Computer 412 also regulates the amount of resin-impregnated tape 224 material supplied by mixer 208.

Upon completion of dispensing, the first resin impregnated tape 224. The dispensing head 224 is laterally shifted and operated to dispense at least one additional strip of the resin-impregnated tape. To dispense at least one additional strip of the resin-impregnated tape, the dispensing head 220 could return into the initial position or dispense the additional tape strip moving in the opposite direction.

The dispenser dispenses the resin-impregnated material tape such that narrow side 104 (FIG. 2C) attaches the resin-impregnated material tape perpendicular to the surface of the 3D object that at least partially supports the resin-impregnated material tape. To place the resing impregnated material tape 224 perpendicular to the surface of the 3D object 404, the material dispensing head 220, as shown by arrow 414, rotates on an angle that places the tape 224 perpendicular to the surface of 3D object 400. Rotation of support surface 404 indicated by arrow 416 and linear movement of support surface 404 indicated by arrow 416 could alternatively or additionally facilitate the placement of the resin-impregnated material tape 224 perpendicular to the surface of the 3D object.

Acrylic materials are at least a component of the matrix of the resin-impregnated tape. Acrylic materials are known as fast or almost immediately curing materials. Accordingly, the resin-impregnated tape cures or hardens immediately, and the extruded resin-impregnated tape remains suspended in the air. The resin-impregnated tape 224 could remain suspended in the air until a certain length that does not cause the tape 224 to bend.

A support surface that at least partially supports the resin-impregnated material tape dispensed by the dispenser could be introduced. The support surface could be flat or curved.

In some examples, the consecutively extruded resin-impregnated tapes could have some joint segments.

In another example, a resin dispensing head could place additional resin at the joints of the strips of the resin-impregnated tape 224 and between the resin-impregnated tape 224 strips to act as an adhesive between consecutive tape strips and between the surface of the 3D object.

In some examples, concurrently with resin-impregnated tape dispensing, a source of curing radiation 236 (FIG. 2) is operated to at least partially fix the dispensed resin impregnated tape 224. The dispensed resin impregnated tape 224, when attached to the surface of the 3D object, forms a rib of the support structure. The source of curing radiation could be a source of UV radiation. In some examples, a source of heat could be operated to soften the resin that serves as a matrix that enhances the tape. The resin hardens upon cooling.

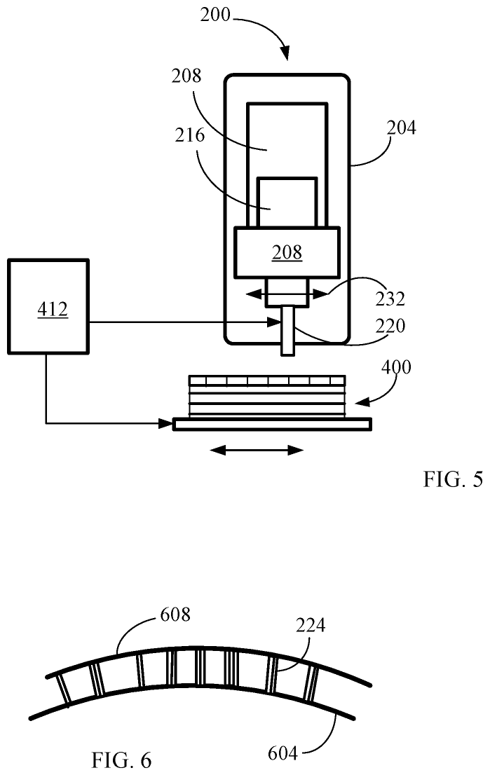

FIG. 5 is a front view of an example of a modified apparatus 200 of FIG. 4.

Typically, a single strip of resin-impregnated tape 224 is applied to a surface of skin 604 of a composite material 3D object. In cases where the required support of the 3D object skins 604 and 608 is higher than the one provided by a single tape 224, several resin-impregnated material tapes can be placed and joined as a multi-layer laminate. (FIG. 6)

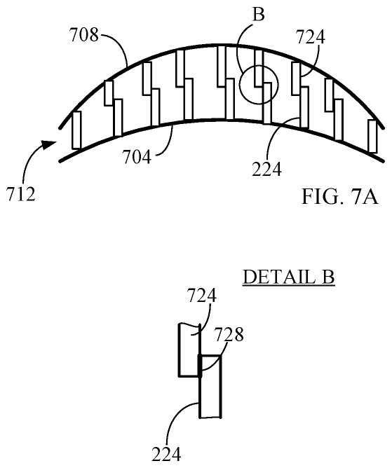

FIG. 7 is an example of a 3D object formed by not concentric curved surfaces and a corresponding strength and stiffness enhancement structure. Two non-concentric curves 704 and 708 form a segment of a composite 3D object. A gap 712 between the two curves 704 and 708 varies along the curves 704 and 708. The required height of the ribs of the strength and stiffness support structure is larger than the resin-impregnated tape 224 height. To compensate for the difference in height of the ribs, an additional segment 724 of a strip of the resin-impregnated tape could be attached to resin-impregnated tape 224. A line of adhesive 720 is applied along the top or side of the previously deposited resin-impregnated tape 224, and then the additional segment of tape 724 is applied. A minimal overlap 728 of 2.0 or 3.0 mm between the two tapes is required to achieve adhesion, but the overlap can be larger than this minimum value, and the total height of a rib can be determined for each location in the structure.

### Method of Manufacture of a 3D Composite Object

The manufacture of a three-dimensional curved composite object includes provision of the first skin 404 (FIG. 4) of a three-dimensional curved composite object 400 and operation of at least one material dispensing head 220 to dispense a resing-impregnated material forming the strength and stiffness enhancement structure. The three-dimensional composite curved object 400 could include curved convex and concave surfaces and flat surfaces. The strength and stiffness enhancement structure is a composite material structure. The structure is located on a first curved composite object 400 skin surface 404. In some examples, before attaching to the skin of the three-dimensional curved surface the strength and stiffness enhancement structure, a layer of glue could be dispensed on the three-dimensional curved surface of the skin.

The strength and stiffness enhancement structure could be of the same composite material as the composite material of the 3D object. In some examples, the strength and stiffness enhancement structure composite material and the composite material of the 3D object are different composite materials.

A source of curing radiation 236 operates to at least partially cure a dispensed resin-impregnated material tape 224 and glue. The resin-impregnated material tape 224 includes at least unidirectional strength and stiffness enhancement materials.

Following the deposition of the strength and stiffness enhancement structure, the second skin 420 of a three-dimensional curved composite object is delivered, as shown by arrow 424, and attached to the deposited earlier strength and stiffness enhancement structure to form a three-dimensional curved composite object (FIG. 4B). The height of the strength and stiffness enhancement structure varies along with a gap 712 (FIG. 7) between the first 704 and second 708 skin of a three-dimensional curved object. (FIG. 7A)

A resin impregnated material tape is the material from which the strength and stiffness enhancement structure is generated. A source of curing radiation 236 is operated to at least partially attach a dispensed resin impregnated tape 224 to the first skin 404 of the three-dimensional curved object 400.

Typically, the first 404 and second skin 420 that form the 3D object are parallel to each other, or concentric curve shapes. However, there are cases where the first 704 and second skin 708 of the three-dimensional curved object are not concentric curves. Strength and stiffness structures supporting segments formed by not concentric curves 704 and 708 fill gaps that vary along the length of the gap.

The strength and stiffness enhancement structure varies the height along with the length of the gap. If the required height of the structure is larger than the resin-impregnated material tape width, additional strip 224 of the tape can be applied. A line of adhesive 728 is applied along the top or side of the previously deposited tape 224, and then additional segment 724 tape is applied. A minimal overlap 728 filled by glue between tapes helps to achieve adhesion, but the overlap can be larger than this minimum value and so the total height can be determined for each location in the structure.

In one example, the first and second skins of the three-dimensional curved composite object and the strength and stiffness enhancement structure produced from the same material. In an additional example, the first and second skins of the three-dimensional curved composite object and the strength and stiffness enhancement structure are manufactured from different materials.

### Apparatus for Manufacture of a Composite Material

FIGS. 4A and 4B illustrate the apparatus that could be used to manufacture a composite material three-dimensional object with curved and flat surfaces. Apparatus for manufacturing of a composite three-dimensional object includes a support surface 408 configured to hold and displace a first curved surface 404 of a three-dimensional object 400 and a material dispensing head 220 configured to dispense the material of a strength and stiffness enhancement structure and locate the structure on a surface of a skin of a first curved composite object surface. A
a glue dispensing nozzle (not shown) configured to dispense the glue on a first curved skin surface 404 in front of a strength and stiffness enhancement structure and a source of curing radiation 236 to cure the material dispensed by material dispensing head 220, that dispenses simultaneously from the same material skins and the strength and stiffness enhancement structure. The apparatus further includes
a computer governing operation of the apparatus and including software configured to accept a three-dimensional object CAD design and transform design parameters of the three-dimensional object into printable 3D object segments, including strength and stiffness-enhancing structure.

The support surface 408 could be a continuous or discrete support surface.

The material dispensing head 220 configured to dispense material of a strength and stiffness enhancement structure dispenses a resin-impregnated material tape 224.

The glue dispensing nozzle dispenses the glue on a first curved surface in front of a strength and stiffness enhancement structure as a continuous strip of glue or discrete drops of glue.

The source of curing radiation could be a source of UV radiation. The heat source could be a source of IR radiation.

It will be appreciated by persons skilled in the art that the present disclosure is not limited to what has been particularly shown and described hereinabove. Rather, the scope of the method and apparatus includes both combinations and sub-combinations of various features described hereinabove and modifications and variations thereof which would occur to a person skilled in the art upon reading the foregoing description and which are not in the prior art.

1-25. (canceled)

26. A method of manufacturing a three-dimensional curved composite object: comprising:
providing a first skin of a three-dimensional curved composite object;
operating at least one dispenser to dispense a strength and stiffness enhancement structure and locating the structure on a surface of a first curved composite object skin;
providing a second skin of a three-dimensional curved composite object and attaching the second skin to dispense a strength and stiffness enhancement structure to form a three-dimensional curved composite object; and
wherein the height of a strength and stiffness enhancement structure varies along with a gap between the first and second skin of a three-dimensional curved object.

27. The method of claim 26, wherein the strength and stiffness enhancement structure is a strength enhanced resin-impregnated material tape.

28. The method of claim 26, wherein operating a source of curing radiation to at least partially attach a dispensed resin-impregnated material tape to the first surface of the three-dimensional curved object.

29. The method of claim 26, wherein the first and second skin of the three-dimensional curved object are not concentric curvatures.

30. The method of claim 26, wherein attaching segments of the strength and stiffness enhancement structure to different parts along a length of the strength and stiffness enhancement structure, varies the height of the strength and stiffness enhancement structure.

31. The method of claim 26, wherein the strength and stiffness enhancement structures are composite material structures.

32. The method of claim 26, wherein dispensing glue on the three-dimensional curved surface before attaching the strength and stiffness enhancement structure to it.

33. The method of claim 26, wherein the first and second skins of the three-dimensional curved composite object and the strength and stiffness enhancement structure are from the same material.

34. The method of claim 26, wherein the first and second skins of the three-dimensional curved composite object and the strength and stiffness enhancement structure are from different materials.

35. The method of claim 26, wherein the three-dimensional composite curved object includes curved convex and concave surfaces and flat surfaces.

36. The method of claim 26, wherein operating a source of curing radiation to at least partially cure a dispensed resin-impregnated material, tape, and glue.

37. The method of claim 26, wherein a resin-impregnated material tape includes at least unidirectional strength and stiffness enhancement materials.

38. An apparatus for manufacturing a composite three-dimensional curved object, comprising:
a support surface configured to hold and displace the first curved surface of a three-dimensional object;
a dispenser configured to dispense material of a strength and stiffness enhancement structure and locate the structure on the surface of the skin of a first curved composite object;
a glue dispensing nozzle to dispense the glue on a first curved surface in front of a strength and stiffness enhancement structure;
a source of curing radiation, wherein an extrusion nozzle extrudes simultaneously from the same material skins and the strength and stiffness enhancement structure; and
a computer governing the operation of the manufacturing apparatus and including software configured to accept a three-dimensional object CAD design and transform design parameters of the three-dimensional object into printable 3D object segments, including strength and stiffness-enhancing structure.

39. The apparatus of claim 38, wherein the support surface is continuous or discrete support surface.

40. The apparatus of claim 39, wherein the dispenser configured to dispense material of a strength and stiffness enhancement structure dispenses a resin-impregnated material tape.

41. The apparatus of claim 40, wherein the nozzle dispenses the glue on a first curved surface a strength and stiffness enhancement structure as a continuous strip of glue or discrete drops of glue.

42. The apparatus of claim 41, wherein a source of curing radiation is a source of UV radiation

43. The apparatus of claim 42, wherein the source of heat is an IR radiation source.
